(19) United States
(12) Patent Application Publication
(10) Pub. No.: US 2002/0029336 A1
(43) Pub. Date: Mar. 7, 2002

(54) Authentication method and authentication system for users attempting to access an information source via communication network, and information processing system and information processing method using the same

(75) Inventors: Hiroaki Sekiyama, Shinagawa-ku (JP); Yuji Ikedo, Kariya-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 09/941,677

(22) Filed: Aug. 30, 2001

(30) Foreign Application Priority Data
Sep. 1, 2000 (JP) 2000-265640

(51) Int. Cl. H04L 9/00

(52) U.S. Cl. 713/169

(57) ABSTRACT

An information processing center correlates and stores a communication terminal ID assigned unique to each communication terminal used by a user and a user ID assigned unique to each user attempting to access, and stores user information correlated with the user ID. Then, the user is identified based on the communication terminal ID received by the information processing center. Consequently, specific service corresponding to each user can be provided and centralization and commonization of information for each user can be promoted.

### INCORPORATION BY REFERENCE

The disclosure of Japanese Patent Application No. 2000-265640 filed on Sep. 1, 2000 including the specification, drawings and abstract is incorporated herein by reference in its entirety.

### BACKGROUND OF THE INVENTION

1. Field of the Invention

The invention relates to an authentication method and authentication system for identifying a user attempting to access via a communication network by using multiple communication terminals such as mobile phones, as well as an information processing system and information processing method using the same.

2. Description of Related Art

With conventional information service that manages and provides information via a communication network, an information management center as a service provider recognizes a communication terminal ID, assigned unique to each communication terminal, which is transmitted from a communication terminal used by a user and received by the information management center. Based on the communication terminal ID, the information management center authenticates the communication terminal as a service receiver, and manages and provides various information according to each communication terminal.

However, the current situation is that, along with the recent diversification of communication terminals and popularization of mobile communication terminals, the number of users who use multiple communication terminals to receive service is on the increase. Under these circumstances, when one user uses multiple communication terminals to receive service, authentication of a communication terminal as a service receiver as described above causes inconvenience to both the information management center and the users.

That is to say, the information management center, since it confirms a communication terminal as a service receiver based on a communication terminal ID, cannot identify a user and thus there is the inconvenience that specific service corresponding to each user cannot be provided. Furthermore, because a communication terminal is confirmed as a service receiver based on a communication terminal ID, various information is managed according to each communication terminal, thereby causing inconvenience that information cannot be centralized for each user.

On the other hand, since each communication terminal is recognized respectively as a service receiver by the information management center and information is managed for each communication terminal, a user cannot use information that was registered by a certain communication terminal by using another communication terminal, and therefore there was the inconvenience that the information cannot be commonized between communication terminals.

### SUMMARY OF THE INVENTION

In view of the foregoing problems, a first object of the invention is to provide an authentication method and authentication system that can identify a user attempting to access via a communication network, regardless of whether different communication terminals are used. A second object of the invention is to provide an information processing system and information processing method with which centralization and commonization of information can be promoted.

Hereinafter, means for achieving the above objects and their operations and advantages are described.

In order to solve the foregoing problems, one method, which is a first aspect of the invention, is to store a communication terminal ID assigned unique to each communication terminal used by a user and a personal ID assigned unique to each user so that the communication terminal ID and the personal ID are correlated, and identify an accessing user by confirming the personal ID based on the received communication terminal ID of the communication terminal of the user.

A second aspect of the invention is an authentication system. This system comprises a storage media that stores a communication terminal ID assigned unique to each communication terminal used by a user and a personal ID assigned unique to each user so that the communication terminal ID and the personal ID are correlated, and authentication means for identifying an accessing user by confirming the personal ID stored in the storage media, based on the received communication terminal ID of the communication terminal of the user.

As mentioned above, a user attempting to access via a communication network can be identified by storing the communication ID and the personal ID so that they are correlated and confirming the personal ID based on the communication terminal ID. Therefore, the information management center can separately confirm each accessing user and thus can provide specific service corresponding to each user. Consequently, even when a user uses multiple communication terminals to receive service, the information management center is able to manage various information according to each user by identifying an accessing user, and therefore centralization of information for each user can be achieved.

An information processing system, which is a third aspect of the invention, comprises a storage media that stores a communication terminal ID assigned unique to each communication terminal used by a user and a personal ID assigned unique to each accessing user so that the communication terminal ID and the personal ID are correlated and that stores personal information of the user by correlating such information with the personal ID, and authentication means for identifying an accessing user by confirming the personal ID stored in the storage media, based on the received communication terminal ID of the communication terminal of the user and allowing the user to access the personal information correlated with the personal ID of that user.

An information processing method, which is a fourth aspect of the invention, is to recognize access to an information source of the user by an information terminal of the user, receive from the information terminal the information terminal ID assigned unique to each information terminal, retrieve a personal ID of the user based on the information terminal ID, and identify the user based on the retrieved personal ID.

Accordingly, the information management center can separately confirm each accessing user and thus can provide specific service corresponding to each user. Even when a user uses multiple communication terminals to receive service, the information management center is able to manage various information according to each user by identifying the accessing user, and therefore centralization of information for each user can be achieved.

Also, since information is managed according to each user by the information management center, a user can use such information between communication terminals, when, for example, a user receives service by using multiple communication terminals. Therefore, the user can be provided with the same service from the information management center even if the user uses different communication terminals. As a result, commonization of information between communication terminals can be achieved.

### BRIEF DESCRIPTION OF THE DRAWINGS

FIG. 1 is a perspective view of an information processing system;

FIG. 2 is a perspective view of information stored in a database;

FIG. 3 is a perspective view of information stored in a database;

FIG. 4 is a flowchart of a user authentication process; and

FIG. 5 is a flowchart of a registration process of a user ID and a communication terminal ID.

### DETAILED DESCRIPTION OF THE PREFERRED EMBODIMENTS

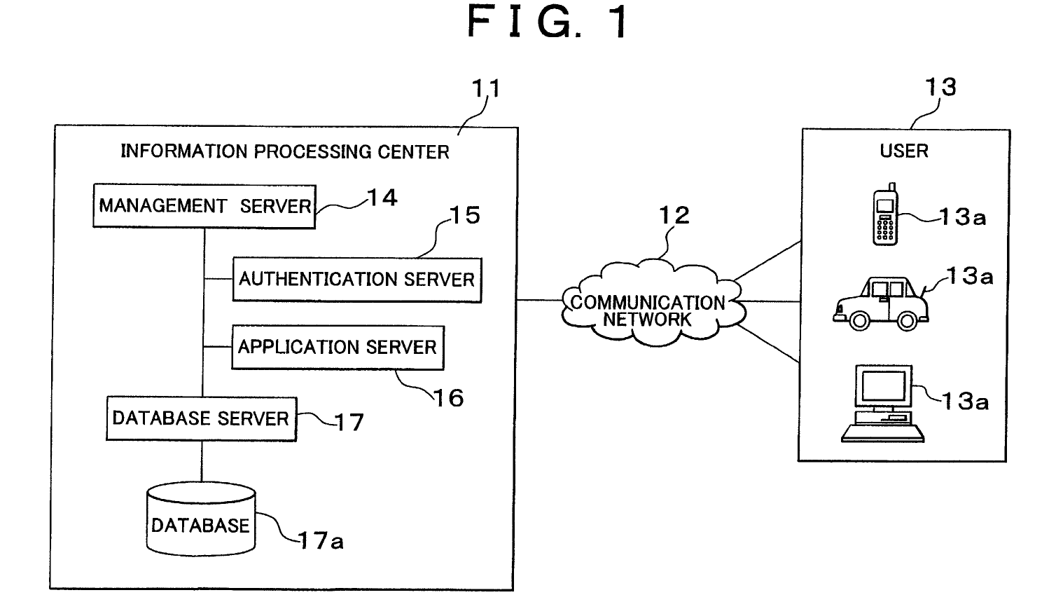

Hereinafter, an information processing system to which the invention is applied will be described referring to FIGS. 1 to 5.

As shown in FIG. 1, an information management center 11 which is a service provider centrally manages various information. Information can be transmitted or received between the information management center 11 and a user 13, which is a service receiver, connected thereto via a communication network 12.

The communication network 12 is not particularly specified and may be either a wired or wireless network. Examples of applicable networks are internet, intranet, LAN (Local Area Network), VAN (Value Added Network), WAN (Wide Area Network) and the like.

The user 13 utilizes with such service as to use information managed in the information management center 11 and receive such information, and has at least one of a plurality of communication terminals 13a. The communication terminal 13a need not be particularly specified as long as it is connectable to the communication network 12 and is capable of receiving and transmitting information. For example, any communication terminal 13a is applicable such as a mobile phone, on-board terminal, PHS (Personal Handy-phone System), PDA (Personal Digital Assistants), PC (Personal Computer) and the like. The communication terminal 13a is provided with a browser as an application software for browsing information provided via the communication network 12 and a receiving/transmitting function for receiving or transmitting data.

The information management center 11 comprises a management server 14 which is connected to the communication network 12 and manages the receipt and transmission of information, an authentication server 15 as authentication means to authenticate the user 13, an application server 16 which executes various programs, and a database server 17.

The management server 14 issues instructions to the authentication server 15 and the application server 16 based on information forwarded from the user 13, receives information read out by the authentication server 15 and the application server 16, and transmits the received information to the user 13.

The authentication server 15 authenticates the user 13 attempting to access via the communication network 12 based on the instructions from the management server 14, and transmits the authentication results and the like to the management server 14. The application server 16 carries out such processes as executing various programs based on the instructions from the management server 14 and transmitting the execution results and the like to the management server 14.

The database server 17 is provided with a database 17a as storage means to store various information, and performs management of the database 17a such as reading out information stored in the database 17a according to the instructions from the management server 14 and transmitting the read-out information to the management server 14.

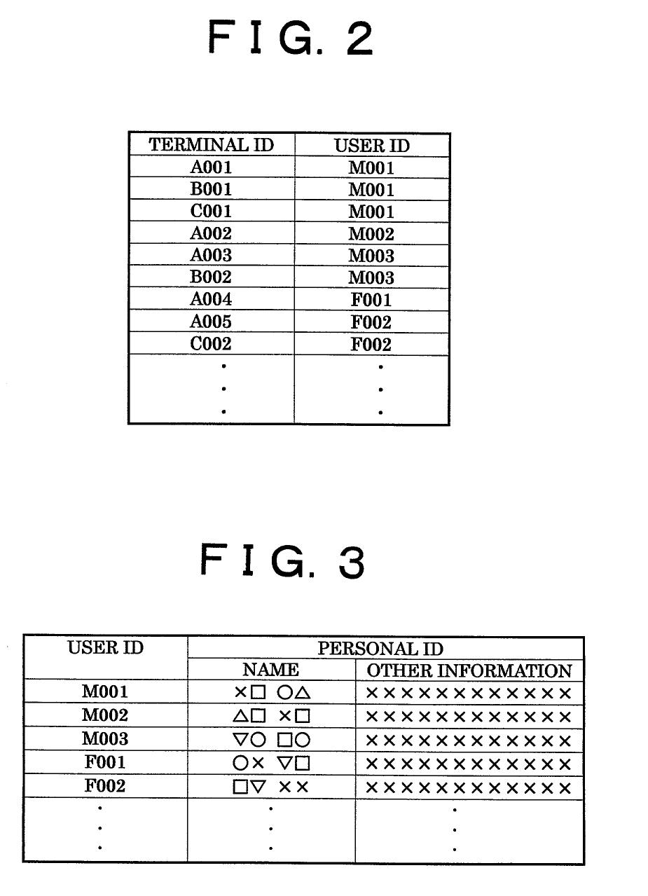

As FIGS. 2 and 3 illustrate, information to be stored in the database 17a of the database server 17 is a user ID 21 which serves as a personal ID, a communication terminal ID 22, user information 23 which is personal information, and the like.

Here, the user ID 21 refers to an identifier assigned unique to each user 13. Therefore, regardless of the number of the communication terminals 13a used by the user 13, one user ID 21 is set for one user 13, and thereby a different identifier is set for each user 13.

The communication terminal ID 22 refers to a unique identifier assigned to each communication terminal 13a used by the user 13. Therefore, a different communication terminal ID 22, or identifier, is set for each communication terminal 13a.

Furthermore, the user information 23 of the user 13 refers to personal information of the user 13 that uses the information management center 11, including such information as the name, sex, date of birth, address, telephone number, e-mail address, personal memos and schedule of the user 13.

The communication terminal ID 22 and user information 23 are stored in the database 17a of the database server 17 correlated with the user ID 21. Therefore, the user information 23 is centrally managed in the information management center 11 according to the user ID 21.

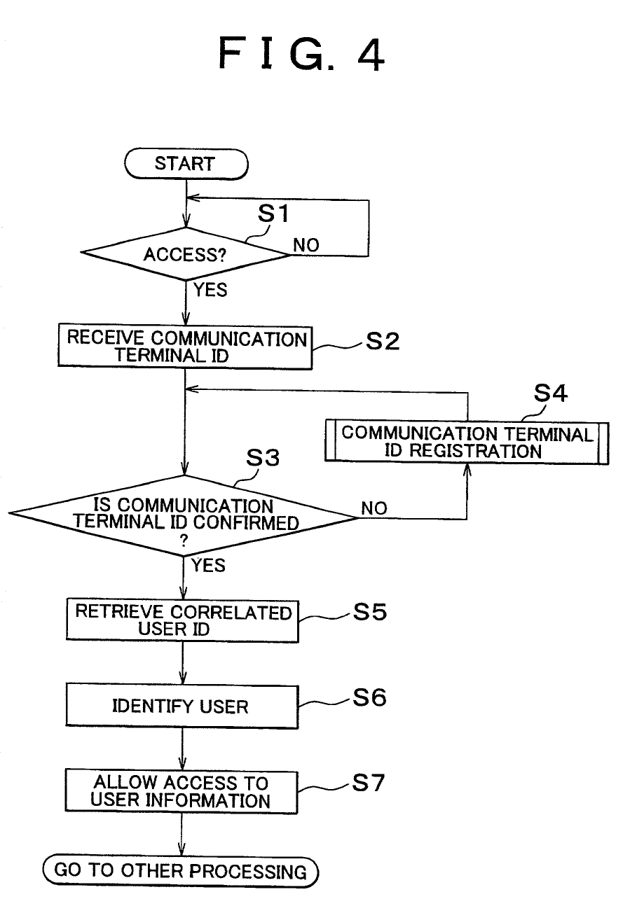

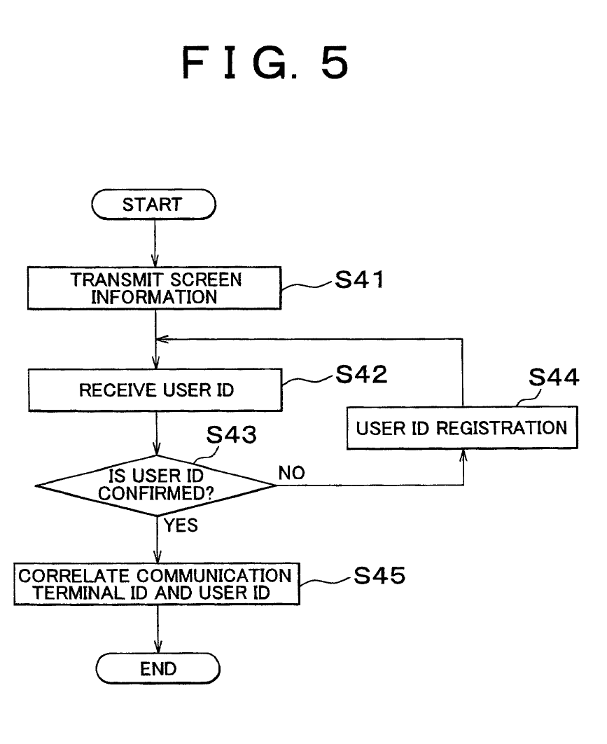

When using the information management center 11, authentication of the user 13 is performed by the authentication server 15. The process for authenticating the user 13 is explained hereinafter referring to FIGS. 4 and 5.

The user 13 accesses the information management center 11 by activating the browser of the communication terminal 13a and connecting it to the communication network 12 (Step S1). When the communication terminal 13a is connected to the information management center 11, the communication terminal ID 22 of the communication terminal 13a used by the user 13 is automatically transmitted, and information of the communication terminal ID 22 is received by the information management center 11 (Step S2). Then, the authentication server 15 confirms whether or not the communication terminal ID 22 of the communication terminal 13a of the accessing user 13 is registered in the database 17a of the database server 17 (Step S3). In this case, if the communication terminal ID 22 is not yet stored in the database 17a of the database server 17, i.e., if the communication terminal ID 22 of the user 13 is not yet registered in the information management center 11, registration of the communication terminal ID 22 is requested and such registration is executed by the user 13 (Step S4).

To register the communication terminal ID 22 in Step S4 above, as shown in FIG. 5, first, screen information is transmitted to the communication terminal 13a from the information management center 11 and input of the user ID 21 is requested in a Web page displayed on the communication terminal 13a (Step S41). When the user 13 inputs the user ID 21, the input information is received by the information management center (Step S42), and the authentication server 15 confirms whether or not the user ID 21 is registered in the database 17a of the database server 17 (Step S43)

At this stage, if the received user ID 21 is not yet registered in the database 17a of the database server 17, i.e., if it is the first time for the user 13 to use the information management center 11, registration of the user ID 21 is requested and such registration is executed by the user 13 (Step S44). When the user ID 21 is registered, the input of the user ID 21 is requested (Step S41) as mentioned above. Information of the user ID 21 that is input is received by the information management center 11 (Step S42) and confirmation of the received user ID 21 is performed (Step S43).

In Step S43, if it is confirmed that the user ID 21 is registered, the communication terminal ID 22 of the communication terminal 13a of the user 13 is stored in the database 17a of the database server 17 correlated with the user ID 21 (Step S45) and the registration of the communication terminal ID 22 is completed.

Then, as shown in FIG. 4, if it is confirmed that the communication terminal ID 22 is registered in Step S3 above, the authentication server 15 retrieves the user ID 21 correlated with the communication terminal ID 22 from the database 17a of the database server 17 (Step S5), and thereby the user 13 is identified (Step S6). Consequently, the user 13 is confirmed as a service receiver by the information management center 11.

The user 13 identified by a series of processes described above is authenticated by the authentication server 15 and is allowed to access the user information 23 correlated with the user ID 21 (Step S7). Accordingly, the user 13 is allowed to access the user information 23 such as a schedule of the user 13 stored in the database 17a of the database server 17. Therefore, even if different communication terminals 13a are used, the user 13 can use his or her own user information 23 when using the application server 16 and the like. As is apparent from the above descriptions, registration of the communication terminal 13a is only required when attempting to access for the first time with that communication terminal 13a, and it is not necessary to register again for the access thereafter using the same communication terminal 13a.

With the aforementioned embodiment, the following advantages can be obtained.

By confirming the user ID 21 based on the communication terminal ID 22 of the communication terminal 13a used by the user 13 which is received by the information management center 11, the accessing user 13 can be identified by the information management center 11. Thereby, even if the user 13 uses multiple communication terminals 13a to receive service, the information management center 11 can identify the user 13 as a service receiver and provide specific service corresponding to each user 13.

In the database 17a of the database server 17, the communication terminal ID 22 assigned unique to each communication terminal 13a used by the user 13 and the user ID 21 assigned unique to the accessing user 13 are correlated and stored, and the user information 23 is stored correlated with the user ID 21. As a result, each user 13 can be clearly confirmed by the information management center 11. Accordingly, even when the user 13 uses multiple communication terminals 13a to receive service, the information management center 11 can manage the user information 23 according to each user 13 by identifying the user 13, thus enabling centralization of the information for each user.

The user ID 21 is confirmed based on the communication terminal ID 22 of the communication terminal 13a of the user 13 which is received by the information management center 11 to allow access to the user information 23 correlated with the user ID 21. Consequently, the user 13 can freely use his or her own user information 23 registered at each communication terminal 13a using different communication terminals 13a. Accordingly, the user information 23 can be made common between communication terminals 13a on the side of the user 13.

The user ID 21 and the user 13 are identified based on the communication terminal ID 22 received by the information management center 11. Therefore, registration of the communication terminal ID 22 of the communication terminal 13a in the information management center 11 is required only for the first access using that communication terminal 13a. For the access thereafter using the same communication terminal 13a, the authentication process is carried out automatically based on the communication terminal ID 22 received by the information management center 11. As a result, the process of authenticating the user 13 can be performed automatically without imposing the burden of going through procedures such as registration and authentication of the user 13 or the communication terminal 13a on the user 13 that uses the information management center 11.

Also, the invention is not limited to the aforementioned embodiment and may be carried out in other forms as described below.

Multiple user IDs 21 are set for one user 13, and the user IDs 21 and the communication terminals 13a are correlated arbitrarily. Even though multiple user IDs are set, the information management center 11 can clearly confirm each user 13 as a service receiver by managing the user 13, the user ID 21, and the communication terminal ID 22. In this case, the user 13 can arbitrarily set a service receiver for the information management center 11, and thus can differentiate the service to be received from the information management center 11 according to each user ID 21 or communication terminal 13a.

The user information 23 stored in the information management center 11 is managed for each user 13 as well as communication terminal 13a identified by the user 13. In this manner, a service receiver is able to be confirmed for each user 13 and communication terminal 13a identified by the user 13, and thus more specific service can be provided. By arbitrarily selecting a service receiver at the information management center 11, such as, for example, providing service according to each user 13 or according to each communication terminal 13a which is used to identify or confirm the user attempting to access the information management center 11 and is identified by the user, specific service can be provided according to each user 13 or communication terminal 13a.

Next, the technical concept that can be derived from the above embodiment with the advantages obtained therefrom will be explained.

An authentication method for identifying a user attempting to access via a communication network, based on a communication ID of a communication terminal used by the user.

By identifying an accessing user based on the communication terminal ID of the communication terminal used by the user, authentication of the user can be carried out without increasing the burden of going through procedures on the user of the information management center.

An authentication method for identifying a user attempting to access via a communication network, based on a communication terminal ID assigned unique to each communication terminal used by a user.

By identifying an accessing user based on the communication terminal ID assigned unique to each communication terminal used by the user, the information management center can easily identify the accessing user and provide specific service corresponding to each user.

An authentication method for identifying a user attempting to access via a communication network using multiple communication terminals by correlating and storing a communication terminal ID assigned unique to each communication terminal used by the user and a personal ID assigned unique to each user, and confirming the personal ID based on the received communication terminal ID of the communication terminal of the user.

Consequently, a user attempting to access with multiple communication terminals can be identified, even if different communication terminals are used.

What is claimed is:

1. An authentication method for identifying a user attempting to access an information source via a communication network, comprising the steps of:
storing a communication terminal ID assigned unique to each communication terminal used by a user and a personal ID assigned unique to each user so that the communication terminal ID and the personal ID are correlated, and
identifying a user attempting to access an information source by confirming the personal ID based on a received communication terminal ID of a communication terminal of a user.

2. An authentication system for identifying a user attempting to access an information source via a communication network, comprising:
a storage media which stores a communication terminal ID assigned unique to each communication terminal used by a user and a personal ID assigned unique to each user so that the communication terminal ID and the personal ID are correlated, and
authentication means for identifying a user attempting to access an information source by confirming a personal ID stored in the storage media based on a received communication terminal ID of a communication terminal of a user.

3. An information processing system for managing and providing personal information of a user attempting to access an information source via a communication source, comprising:
a storage media which stores a communication terminal ID assigned unique to each communication terminal used by a user and a personal ID assigned unique to each accessing user so that the communication terminal ID and the personal ID are correlated and which stores personal information of the user correlated with the personal ID, and
authentication means for allowing access to the personal information correlated with the personal ID of the user by confirming the personal ID stored in the storage media based on a received communication terminal ID of the communication terminal of the user and identifying the user attempting to access an information source.

4. An information processing method for managing and providing personal information of a user attempting to access an information source via a communication network, comprising the steps of:
recognizing access to an information source of the user by an information terminal of the user,
receiving from the information terminal an information terminal ID assigned unique to each information terminal,
retrieving a personal ID of the user based on the information terminal ID, and
identifying the user based on the personal ID retrieved.

5. The information processing method according to claim 4, comprising the steps of:
allowing a user identified in the identifying process to access personal information stored in the information source.

6. The information processing method according to claim 4, wherein
the information terminal ID and the personal ID are correlated and stored, and
the personal ID is retrieved based on the information terminal ID in the retrieving process.
